(19) United States
(12) Patent Application Publication
(10) Pub. No.: US 2007/0227862 A1
(43) Pub. Date: Oct. 4, 2007

(54) Durable Switches and Methods for Using Such

(76) Inventors: Steve Y. Yim, Rowland Heights, CA (US); Man S Wong, City One (HK)

Correspondence Address: THE HAMILTON LAW FIRM PC, 8555 W. BELLEVIEW AVE., G21-139, LITTLETON, CO, 80123, US

(21) Appl. No.: 11/573,340

(22) PCT Filed: Aug. 23, 2005
(86) PCT No.: PCT/US05/29838

§ 371 Date: Feb. 6, 2007

Related U.S. Application Data
(60) Provisional application No. 60/606,221, filed on Aug. 31, 2004.

(51) Int. Cl. H01R 33/96

(52) U.S. Cl. 200/51.09

(57) ABSTRACT

Among other things, various durable switches are disclosed that can include a switch housing, an actuator element, and a field element. The switch element can include a channel defined by a channel base, at least one channel side, and at least one open end. The actuator element can be rotatably mounted to the channel side such that rotation of the actuator element causes an outer point of the actuator element to position at a location proximate the channel base. In this position, a passage through the open end is substantially larger than a passage between the outer point of the actuator element and the point proximate the channel base. Further, rotation of the actuator element causes a change in location of the field element that can effectuate switching.

### BACKGROUND OF THE INVENTION

Various embodiments of the present invention relate generally to switching technology, and more particularly to durable switches and methods of using such.

Various switches exist for use in a number of different applications. A typical switch includes a mechanical element that is physically moved causing a physical connect/disconnect between two or more electrical contacts. Such switches are susceptible to damage from a number of environmental factors including, for example, corrosion build up on the electrical contacts and obstructions impeding movement of the mechanical element. Seals or other blocking devices have been formed around the mechanical element to limit interference of obstructions with the mechanical element. However, such seals can be costly and in some cases ineffective.

Thus, for the aforementioned reasons and others, there exists a need in the art for advanced systems, apparatus, and methods for switching.

### BRIEF SUMMARY OF THE INVENTION

Various embodiments of the present invention provide switches that offer one or more features aiding in, among other things, the functionality, durability, accessibility, and/or non-clogging aspects of a switch. Some embodiments of the present invention provide switches with an actuator and a field switching element. In such embodiments, the actuator can be open such that obstructions in proximity the actuator can be removed, and in some cases the actuator can be utilized to encourage removal of the obstructions.

Some other embodiments of the present invention provide durable switches. Such durable switches include a switch housing, an actuator element, and a field element. The switch housing includes a channel defined by a channel base, at least one channel side, and at least one open end. The channel base can be one of a variety of forms including, but not limited to, a planar topography, a curvilinear topography with a rounded plane disposed in the channel, or another topography exhibiting minimal impedance to moving debris, obstructions, and/or contaminants from within the channel.

The actuator element is rotatably mounted to the channel side and rotation of the actuator element causes an outer point of the actuator element to assume a position at a location proximate the channel base. In this position, a passage through the open end of the channel is substantially larger than a passage between the outer point of the actuator element and the point proximate the channel base. In one particular case, the distance from the outer point of the actuator element to the channel is zero. Further, rotation of the actuator element causes a change in location of the field element. In one particular instance of the aforementioned embodiments, the actuator element has a generally cylindrical shape where the outer point of the actuator element is disposed along an outer perimeter defined by the outer edge of the generally cylindrical shape. In such a configuration, the actuator element can have one or more denticles distributed along the outer edge that are, among other things, operable to encourage an obstruction disposed in the channel toward the open end when the actuator element is rotated.

In one case, the outer point is located at an area on one of the denticles most distant from the axis of rotation. Upon rotation of the actuator element, the outer point passes nearer to the channel base than to the open end. In one or more instances of the aforementioned embodiments, the actuator element is capable of rotation through one hundred, eighty degrees, and in some instances, the actuator element is capable of rotation through three hundred, sixty degrees.

In some particular instances of the aforementioned embodiments, the channel side is one of two channel sides that are arranged approximately parallel to one another with the actuator element attached to a rotational axis coupled between the two channel sides. Further, the open end is one of two open ends disposed on either side of the actuator element between the two channel sides. In this configuration, the actuator element can be rotated such that an obstruction within or near the channel that is in contact with the actuator element is encouraged to move away from the actuator element and toward one of the open ends.

In some cases, the switch also includes a field activated switch element that is responsive to the field element. The field element can be, for example, a magnet generating a magnetic field, and the field activated switch element can be a switch element responsive to the magnetic field. Thus, as just one example, the field activated switch element can be a Reed switch.

In one particular case, the field activated element is disposed within a sealed flashlight casing. The flashlight casing can be factory sealed leaving the field activated switch element less susceptible to damaging environmental factors. Further, the actuator element can be disposed on the outside of the sealed flashlight casing. In some cases, the switch casing is integrated with the flashlight casing, while in other cases, the switch casing is mounted to the flashlight casing or otherwise disposed in relation to the flashlight casing.

Other embodiments of the present invention provide durable, non-clogging switches that include a switch housing, an actuator element, a magnet coupled to the actuator element, and a magnetically activated switch disposed in relation to the switch housing. The switch housing includes a channel, and at least a portion of the actuator element is within the channel. The actuator element is mounted such that it can rotate, and upon rotation is operable to displace an obstruction within the channel toward an open side of the channel. Further, rotation of the actuator element brings the magnet within switching proximity of the magnetically activated switch.

Yet other embodiments of the present invention provide factory sealed flashlights that include: a flashlight body that is factory sealed surrounding a magnetically activated switch, and a switch activator disposed in proximity to the magnetically activated switch. The switch activator includes a switch housing with an open channel and an actuator element rotatably mounted to the switch housing. A magnet is coupled to the actuator element, and rotation of the actuator element causes the magnet to move within switching proximity of the magnetically activated switch.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is an exploded view of a switch in accordance with various embodiments of the present invention;

FIGS. 2 depict cross-sectional views of the switch of FIG. 1;

FIG. 3 is a cross-sectional view of an actuator element in relation to a channel base according to various embodiments of the present invention;

FIG. 4 is a cross-sectional view of the actuator element of FIG. 3 disposed in a different relationship to the channel base according to other embodiments of the present invention;

FIGS. 5 show cross-sectional views of another actuator element disposed in relation to the channel base in accordance with yet other embodiments of the present invention;

FIG. 6 depicts a sealed flashlight including a switch in accordance with one or more embodiments of the present invention;

FIG. 7 depicts another locking feature in accordance with other embodiments of the present invention; and

FIGS. 8 depict yet another locking feature in accordance with other embodiments of the present invention.

### DETAILED DESCRIPTION OF THE INVENTION

Various embodiments of the present invention provide switches that offer one or more features aiding in, among other things, the functionality, durability, accessibility, and/or non-clogging aspects of a switch. Some embodiments of the present invention provide switches with an actuator and a field switching element. In such embodiments, the actuator can be open such that obstructions in proximity the actuator can be removed, and in some cases the actuator can be utilized to encourage removal of the obstructions.

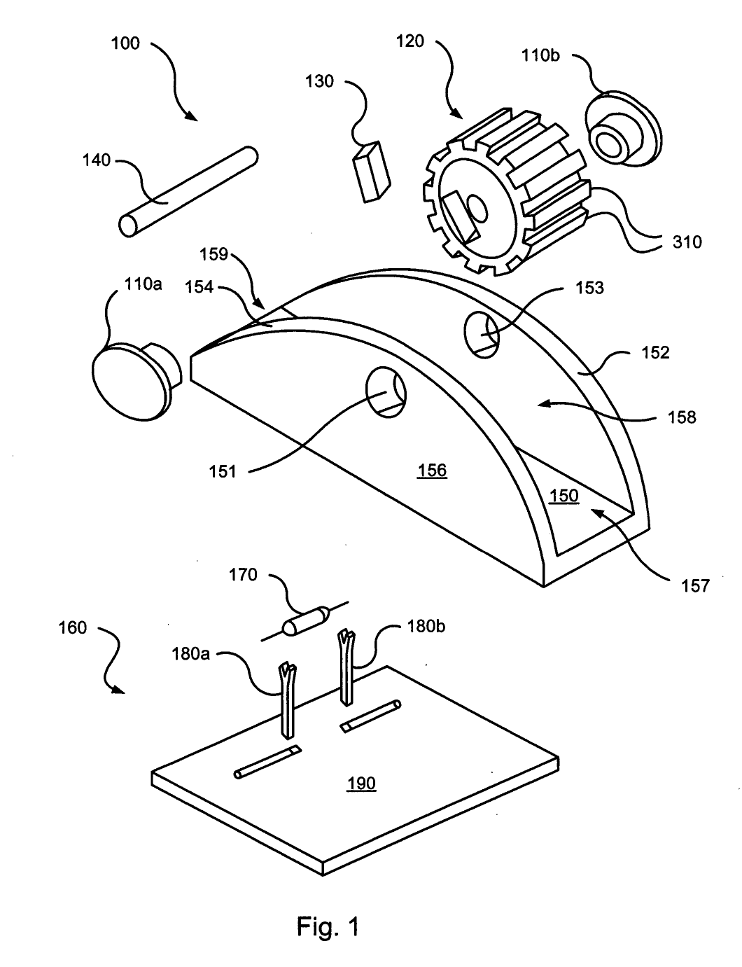

Referring to FIG. 1, an exploded view of a switch activator 100 and a switching element 160 in accordance with some embodiments of the present invention is depicted. Switch activator 100 includes a switch housing 156 including two opposing sides 152, 154; a channel base 150, and an open channel 158 extending between sides 152, 154 and a distal opening 159 and a proximal opening 157 between the respective distal and proximal ends of sides 152, 154. Switch activator 100 further includes an actuator element 120, and a field element 130 coupled to actuator element 120. Actuator element 120 rotatably couples to sides 152, 154 via a rotational axis or shaft 140 extending between holes 151, 153. The ends of rotational axis 140 are covered by respective shaft caps 110 when switch activator 100 is assembled.

Various materials can be used to form the aforementioned elements. For example, the elements can be made of durable materials such as, but not limited to, nylon, polycarbonate, and/or metals. Where metal is desired and field element 130 generates a magnetic field, non-magnetic (non-paramagnetic and/or non-ferromagnetic) materials such as aluminum or brass are often chosen. Such materials exhibit only limited or no magnetic affinity and do not interfere with a magnetically activated switch element, nor do they have a tendency to stick in one or more positions due to the transferred magnetic field. The housing can be made of plastic, polypropolene, and/or nylon, as well metals such as aluminum, brass, bronze, platinum, titanium or non-magnetic stainless steel. The choice of housing materials is determined by considering such things as required durability of the product, manufacturability, product cost, and/or affinity to the selected switching field type.

As illustrated, actuator element 120 has a generally cylindrical shape with an outer perimeter that moves within open channel 158 as actuator element 120 is rotated. In the illustrated embodiment, actuator element 120 can be knurled or include denticles 310 that allow a positive, non-slip grip. Denticles 310 can be added by applying a knurled outer band on actuator element 120, or by forming denticles integral to actuator element 120. For example, a generally planar outer surface associated with actuator element 120 can be knurled to create depressions in the surface, or actuator element 120 can be molded or cast to include denticles 310. Denticles 310 can include rectangular, rounded or trapezoidal shaped sides extending away from a lower surface of the outer perimeter, and they can have rounded or straight tops connecting the sides. In one particular embodiment, a width of the outer perimeter is less than the diameter of actuator element 120.

Switching element 160 includes a field activated switch 170 electrically coupled to two conductive posts 180 that are each respectively coupled to a printed circuit board 190. Switching element 160 is disposed such that field element 130 can be manipulated into and out of a switching proximity of field activated switch 170. This causes field activated switch 170 to connect (i.e, close) and disconnect (i.e., open) electrical current carrying capacity between conductive posts 180. When field activated switch 170 is activated (i.e., closed) energy in the circuit flows through the load. Depending at least in part upon the rating of field activated switch 170, an electrical current can be passed of a typical magnitude of milli-amperes to one or more amperes.

As just one example, where the aforementioned rotary switch mechanism is used to directly control on and off switching of an electronic circuit via a Reed switch, the current that passes through the reed switch is typically in terms of tens of milli-Amperes. As another example, where the aforementioned rotary switch mechanism is used to control the actuation coil of DC, AC or battery operated electrical relay, higher magnitude electrical current may be switched. In some cases, the magnitude of the switched electrical current can be thirty amperes or more depending upon the selected electrical relay. Furthermore, in some cases, the rotary switch mechanism in accordance with embodiments of the present invention can be used to control the actuating coil of a relay which has several pairs of contacts. When each pair of contact is controlling a separate electrical circuitry, several different circuits can be controlled. In such a case, the magnitude of switched current can be very high. Based on the disclosure provided herein, one of ordinary skill in the art will recognize that a switch in accordance with some embodiments of the present invention can also be used to control electronic components such as transistors and Silicon Controlled Rectifiers (SCR) that can handle currents of a range of magnitudes.

It should be noted that electrical sparks can be generated when electrical current is being switched, especially at relay contacts that connect to higher voltages and higher current. By encapsulating the controlling relay inside an enclosure and using a switch in accordance with embodiments of the present invention, the potential for creating an open electrical spark is reduced or even eliminated. This can avoid the potential for igniting flammable substances such as gases that may cause explosions. Such a device can be particularly applicable in, for example, chemical plants, test labs, mining sites and military facilities.

In some embodiments of the present invention, a rotary switch mechanism similar to that described above includes a magnet that serves as field element 130. Such a magnet can be made of neodymium, iron and boron. Alternatively, as will be appreciated by one of ordinary skill in the art based upon reading this disclosure, other materials such as samarium or pure iron can also be used. Neodymium ceramic magnets have the advantage of having extremely high magnetic field strengths thereby allowing the magnet to be quite small while still being able to activate a proximate reed switch. Also, in some embodiments of the present invention, the magnet is plated with nickel or zinc to protect it from corrosion.

In such an embodiment, the magnet provides a magnetic field capable of actuating field activated switch 170 that can be, for example, a Reed switch or the actuation coil of a direct current (DC), alternating current (AC) or battery operated electrical relay. Based on the disclosure provided herein, one of ordinary skill in the art will recognize other field elements and corresponding field activated switches that can be used in accordance with one or more embodiments of the present invention. For example, field element 130 may be selected to generate an optical field such as a light source and field activated switch 170 can be a light activated switch. As other examples, fields such as sound and electrical fields could possibly be used in accordance with the present invention.

The magnet can be inserted into actuator element 120 in an off-center orientation. Actuator element 120 is positioned between opposing sides 152, 154 within open channel 158 of switch housing 156. Actuator element 120 is secured in place by, among other things, rotational axis 140 disposed between holes 151, 153. The off-center orientation of the magnet within actuator element 120 causes the distance from the magnet to open channel base 150 to change as actuator element 120 is rotated around rotational axis 140. Thus, a magnetically activated switch can be disposed at a position relative to the base of open channel 158 such that rotation of actuator element 120 can cause the magnet to move into and out of a switching proximity of the magnetically activated switch. In some cases, the magnet is glued to actuator element 120, while in other cases, the magnet is merely inserted into a preformed slot formed in actuator element 120. In yet other cases, the magnet is integrally formed into actuator element 120 by, for example, incorporating the magnet during a plastic molding process used to form actuator element 120. Further, based on the disclosure provided herein, one of ordinary skill in the art will recognize a number of field elements that can be used, as well as, a number of methods for attaching and/or associating the chosen field element with the actuator element.

For example, in one particular embodiment, a magnet is pressed into a pocket in a nylon actuator element 120 and then sealed and locked in place. Actuator element 120 is then dropped into a notch in switch housing 158 and locked in place with rotational axis 140 made of nylon. End caps 110 made of polypropylene are then pressed over respective ends of rotational axis 140 such that caps 110 extend through holes 151, 153 and over rotational axis 140. These materials exhibit relatively small expansion coefficients, thus limiting a propensity for the device to bind up or become too loose during changes from hot to cold and vice versa. Further, these materials exhibit resistance to a broad range of chemicals. These material properties, among other things, can support a substantially frictionless bearing interface, thereby eliminating wear and fatigue of the parts. Among many advantages that will be apparent to one of ordinary skill in the art, this embodiment provides a switch mechanism that is durable, utilizes low cost materials, and/or is easily manufactured. Such a switch can be used over prolonged periods and/or in abusive environments, while remaining substantially free of clogging or jamming by mud, or becoming corroded by salt or caustic chemicals. Such a switch can also survive relatively severe impacts, vibration and temperature extremes. Further, such a switch can be easily operated using a bare hand or a glove covered hand. A switch should also be easy to operate, even when gloves are worn. Yet further, such a switch can be non-sparking and capable of operation in explosive environments.

Once pressed into position, a ridge feature of end caps 110 limits the ability for end caps 110 to back out of holes 151, 153 of switch housing 150. In some cases, rotational axis 140 rotates relative to and within end caps 110. In such a situation, a clearance between an outer diameter of rotational axis 140 and a corresponding inner diameter of end caps 110 can be very small. This tolerance can be chosen such that most contaminants are precluded from entering the space between end caps 110 and rotational axis 140. This can promote easy movement of actuator element 120 and/or reduce the amount of damage accruing to rotational axis 140 and/or end caps 110 when actuator element 120 is rotated. In one particular example, the slip fit between rotational shaft 140 and cap ends 110 is between 0.0005 inches and 0.001 inches. Also, the coefficient of thermal expansion of rotational shaft 140 and caps 110 can be closely matched to assure similar functionality during different climate conditions.

In other cases, end caps 110 and rotational axis 140 are affixed to switch housing 158, and actuator element 120 rotates relative to rotational axis 140. In such a case, a clearance between an outer diameter of rotational axis 140 and a corresponding inner diameter of actuator element 120 can be very small. This tolerance can be chosen such that most contaminants are precluded from entering the space between rotational axis 140 and actuator element 120. This can promote easy movement of actuator element 120 and/or reduce the amount of damage accruing to rotational axis 140 and/or actuator element 120 when actuator element 120 is rotated. In one particular example, the slip fit between rotational shaft 140 and actuator element 120 is between 0.0005 inches and 0.001 inches. Also, the coefficient of thermal expansion of rotational shaft 140 and actuator element 120 can be closely matched to assure similar functionality during different climate conditions.

In other cases, rotational axis 140 is substantially affixed to end caps 110, and end caps 110 rotate within holes 151, 512. In such a situation, a clearance between an outer diameter end caps 110 and corresponding inner diameters of holes 151, 153 can be very small. This tolerance can be chosen such that most contaminants are precluded from entering the space between end caps 110 and holes 151, 153. This can promote easy movement of actuator element 120 and/or reduce the amount of damage accruing to holes 151, 153 and/or end caps 110 when actuator element 120 is rotated. In one particular example, the slip fit between end caps 110 and holes 151, 153 is between 0.0005 inches and 0.001 inches. Also, the coefficient of thermal expansion of end caps 110 and switch housing 158 can be closely matched to assure similar functionality during different climate conditions.

In yet other cases, rotational axis 140 rotates within end caps 110, and end caps 110 rotate within holes 151, 512. In such a situation, a clearance between an outer diameter end caps 110 and corresponding inner diameters of holes 151, 153 can be very close in tolerance. Further, a clearance between an outer diameter of rotational axis 140 and a corresponding inner diameter of end caps 110 can be very close in tolerance. These small tolerances can be chosen such that most contaminants are precluded from entering the space between end caps 110 and holes 151, 153, and/or between rotational axis 140 and end caps 110. This can promote easy movement of actuator element 120 and/or reduce the amount of damage accruing to holes 151, 153, end caps 110, and/or rotational axis 140 when actuator element 120 is rotated.

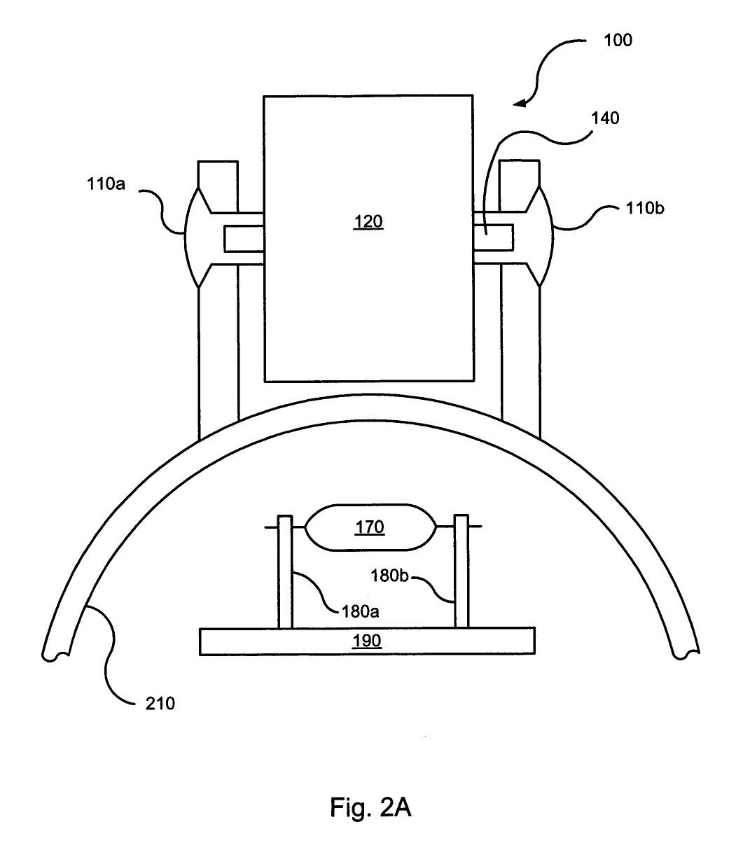

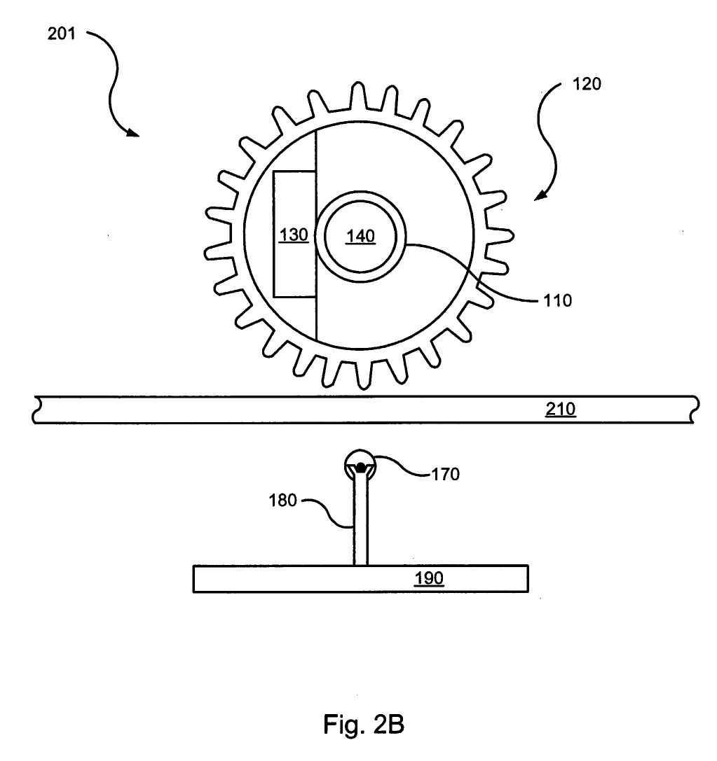

Turning to FIGS. 2, a front cross sectional view 200 (FIG. 2A) and a side cross sectional view 201 (FIG. 2B) of an assembled switch activator 100 and switching element 160 are illustrated. As shown, actuator element 120 is disposed between sides 152, 154 of switch housing 156. In this position, switch actuator element 120 is free to rotate around rotational axis 140. Field element 130 is disposed within actuator element 120 such that it comes within switching proximity of field activated switch 170 when actuator element 120 is rotated. Further, field element 130 is moved out of switching proximity when actuator element 120 is further moved. As illustrated, field activated switch 170 is disposed within a casing 210.

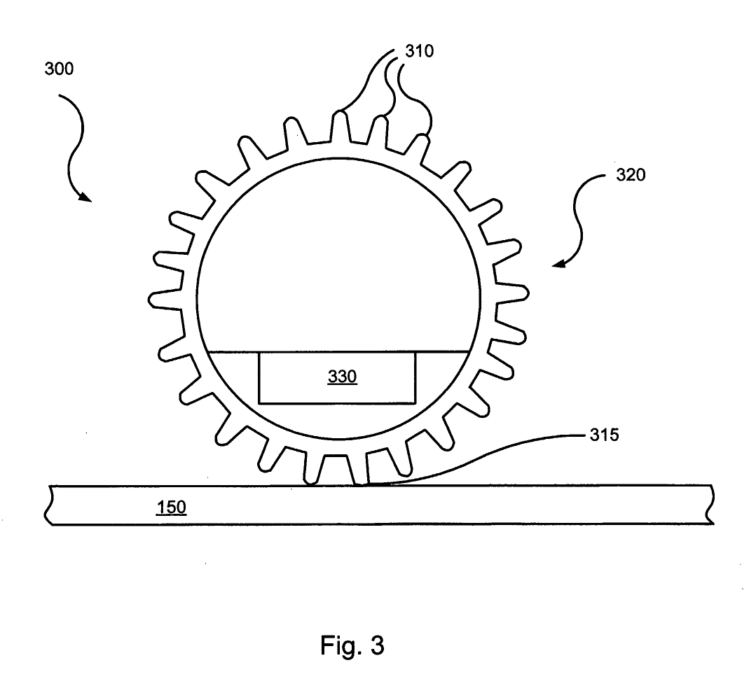

FIG. 3 depicts a cross sectional view 300 of an actuator element 320 in accordance with some embodiments of the present invention. Actuator element 320 is shown positioned relative to channel base 150. As illustrated, a field element 330 is disposed within actuator element 320, and actuator element 320 includes a number of denticles 310 disposed, formed, and/or attached on the outer perimeter of actuator element 320. As illustrated, one or more of denticles 310 contact channel base 150 at a point 315. This provides some resistance in turning actuator element 320, and can act as a stop to hold actuator element 320 in a fixed location. Thus, for example, where it is desired to maintain actuator element 320 in an on position, actuator element 320 is rotated into a position where field element 330 is disposed within a switching proximity of an associated field activated switch (not shown). In this position, the denticle contacting channel base 150 holds the switch in the on position. Similarly, when the off position is desired, actuator element is rotated until the switch turns off and another denticle contacts channel base 150 at position 315. This other denticle maintains the switch in the off position.

Based on the disclosure provided herein, one of ordinary skill in the art will recognize that fewer than all of denticles 310 may contact channel base 150. In one particular case, two denticles that are each longer than other denticles can be provided. In such a case, these two denticles may correspond respectively to an on and off position of the switch. In such a situation, when one of the longer denticles is contacting open channel 158, actuator element 320 must be rotated with enough force to snap past the denticle in contact with open channel base 150. As the denticle contacts and moves past channel base 150, the denticle, rotational axis, and/or actuator element 320 can deform slightly. The deforming element or combination of elements act as a spring that returns to its original form once the denticle passes channel base 150. In some cases, the deformation is approximately 0.010 inches.

Further, when actuator element 320 is rotated, any contaminants or debris are moved toward an end of open channel 158 and away from the switch. As one advantage, the normal operation of the switch and/or frequent or more vigorous operation of the switch can act to clear the switch of any potentially clogging and/or jamming debris. In one particular embodiment of the present invention, the ends of open channel base 150 are open (i.e., substantially unobstructed) such that contaminants and/or debris can be moved away from actuator element 320 and away from a surrounding switch housing (not shown here). Further, the open nature of the switch allows the switch to be cleaned by blowing water by switch activator 320, and/or by immersing the switch in a cleaning solvent such as water and operating the switch to move any contaminants away from actuator element 320.

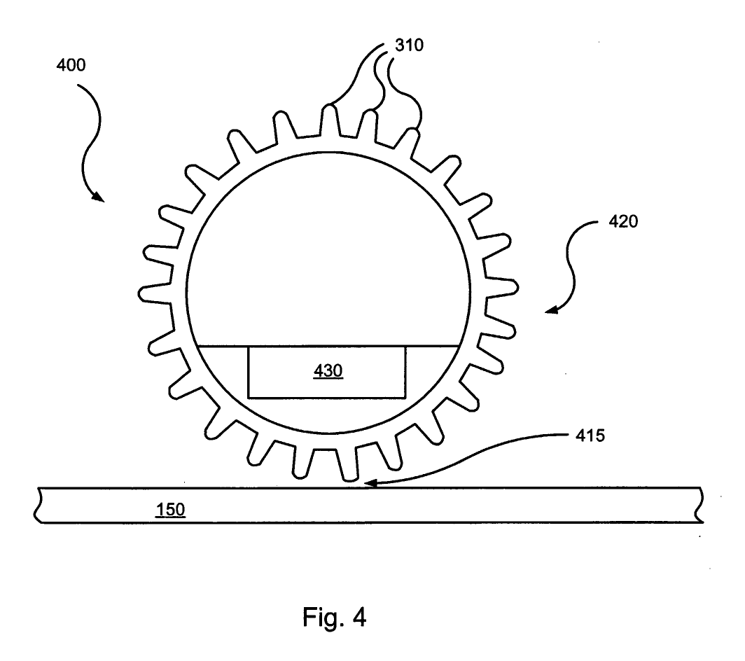

Turning to FIG. 4, a cross sectional view 400 of an actuator element 420 in accordance with some embodiments of the present invention is illustrated. Actuator element 420 is shown positioned relative to channel base 150. In contrast to that described in relation to FIG. 3, denticles 310 do not contact channel base 150, and do not provide stopping functionality.

As with that described in relation to FIG. 3, when actuator element 420 is rotated, any contaminants or debris are moved toward an end of open channel 158 and away from the switch. As one advantage, the normal operation of the switch and/or frequent or more vigorous operation of the switch can act to clear the switch of any potentially clogging and/or jamming debris. In one particular embodiment of the present invention, the ends of open base 150 are open (i.e., substantially unobstructed) such that contaminants and/or debris can be moved away from actuator element 420 and away from a surrounding switch housing (not shown here). Further, the open nature of the switch allows the switch to be cleaned by blowing water by switch activator 420, and/or by immersing the switch in a cleaning solvent such as water and operating the switch to move any contaminants away from actuator element 420.

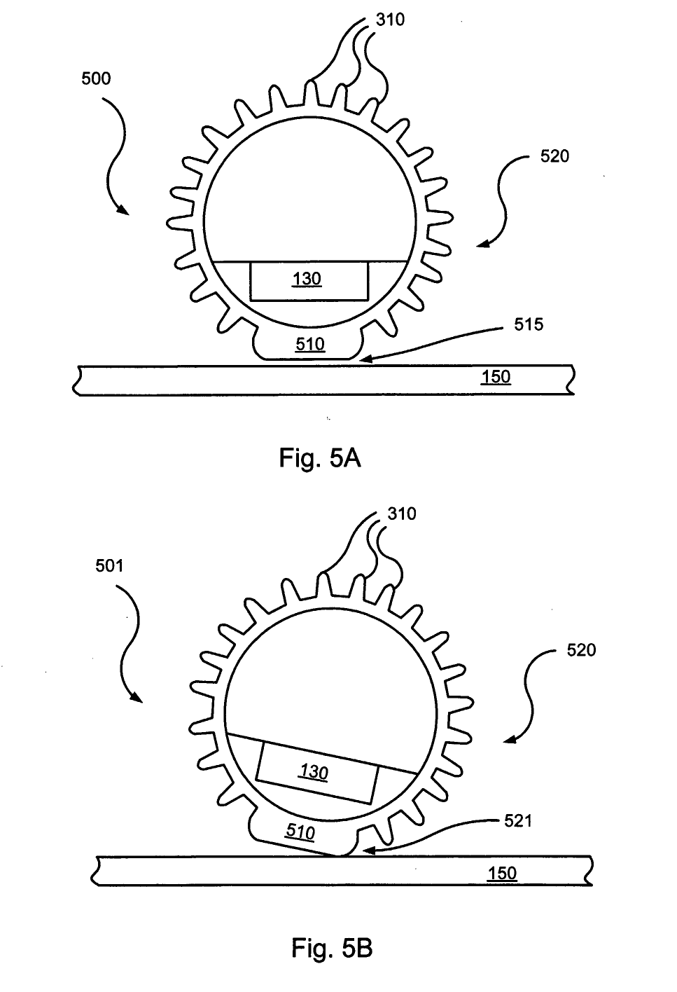

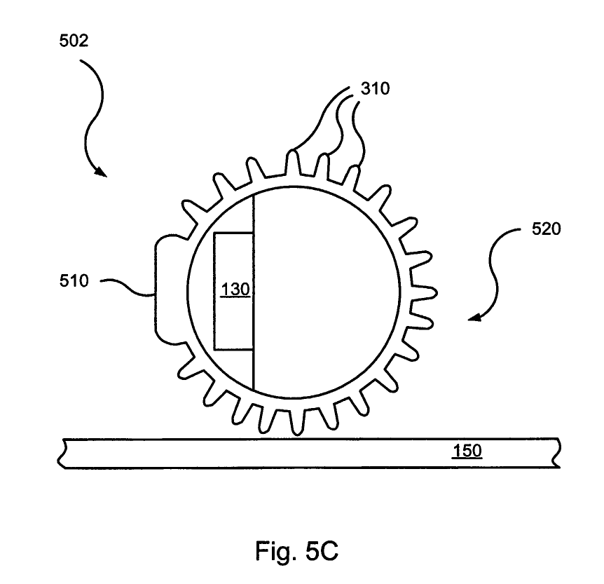

Turning to FIGS. 5, cross sectional views 500-502 of an actuator element 520 in accordance with some embodiments of the present invention. Actuator element 520 is shown positioned relative to channel base 150. In contrast to that described in relation to FIG. 3, actuator element 520 includes a flat stop 510 in addition to denticles 310. Flat stop 510 provides a position identification indicative of the on and off position of the switch. As illustrated in FIG. 5A, when actuator element 520 is rotated such that the flat portion of flat stop 510 is disposed near open channel base 150 at a location 515, the switch is in the “on” position.

As illustrated in FIG. 5B, actuator element 520 can be further rotated to where a corner of flat stop 510 contacts channel base 150 at a location 521. The flat portion of flat stop 510 acts as a stop and the corner of flat stop 510 serves as lock which prevents actuator element 520 from accidentally changing positions due to vibration or shock. In order to change positions, actuator element 520 is rotated with enough force to snap past the corner of flat stop 510. As actuator element 520 rotates through the corner of flat stop 510, the rotational axis affixing actuator element 520 to the switch housing flexes slightly. The rotational axis therefore acts as spring and returns to its original form once the corner of flat stop passed. This flex can be, for example, approximately 0.010 inches and well within the elastic properties of many materials. As illustrated in FIG. 5C, once the corner of flat stop 510 is exceeded, actuator element 520 can be freely rotated such that field element 130 is moved away from channel base 150.

Switches in accordance with embodiments of the present invention can exhibit one or more advantages when compared to other switches such as, for example, reliability. Whether subjected to rough handling, extreme temperatures, clogging or corrosive substances, or the passage of time, various switches in accordance with the present invention offer the ability to withstand such conditions. In some cases where a Reed switch is employed, one or more switches in accordance with the present invention can be rated at over 700,000 cycles, and can withstand substantial abuse without failing, and operate effectively across a temperature range from negative sixty (−60) degrees Fahrenheit to one hundred fifty (150) degrees Fahrenheit. Various switches in accordance with embodiments of the present invention can operate even when caked with mud, and will withstand most common chemicals such as salt water, cleaning agents, and motor oils and fuels. By comparison, push button or toggle switches have components that corrode and springs that fatigue after a few thousand on/off cycles, and sliding switches will easily seize when dirt or grime fills the sliding area. Yet other embodiments of the present invention provide switches that are inherently waterproof (e.g., liquid sealed) where the field activated switch element is encased, and actuated by a field element disposed outside the sealed case. Thus, in some cases, a switched application intended to be liquid sealed can be implemented without requiring complicated and expensive liquid tight seals. This can further increase the durability of an application where rubber or elastomer seals typically degrade when exposed to sunlight or solvents and can be an important cause of degradation in an application. Further, one or more switches in accordance with the present invention can be developed such that the electrical switching circuit is not exposed to the outside world, significantly reducing or eliminating the possibility of igniting combustible materials in a surrounding environment. Accordingly, some switches in accordance with the present invention are well suited for applications that are relied upon to work anytime, even when exposed to harsh or dangerous environments. One or more of the aforementioned advantages, or other advantages can be exhibited by one or more embodiments of the present invention.

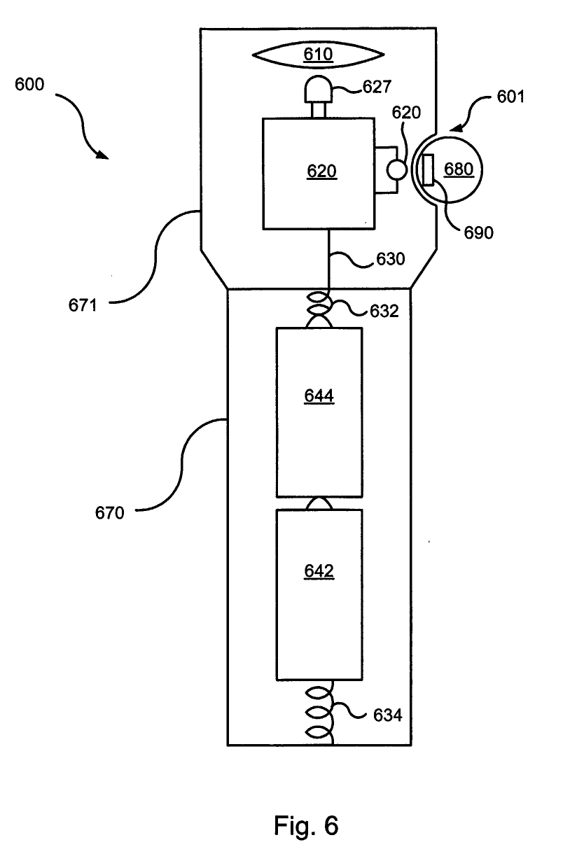

Turning to FIG. 6, one use of a switch in accordance with the present invention is illustrated. In particular, a flashlight 600 including a switch is illustrated. Switch 601 includes an actuator element 680 with a field element 690 disposed therein. Further, switch 601 can include a field activated switch 625 disposed within a sealed casing 671. Further, flashlight 600 can include a power source 642, 644, electrical contacts 632, 634 sealed within a casing 670, and light circuitry 620, a light bulb 627 and a lens 610 sealed within casing 671. In one particular case, switches in accordance with the present invention can be used in relation to a renewable energy flashlight such as those disclosed in U.S. Pat. Nos. 6,220,719 and 5,975,714. Such renewable energy flashlights can be factory sealed. Both of the aforementioned patents are assigned to an entity common hereto, and the entirety of both patents is incorporated herein by reference for all purposes.

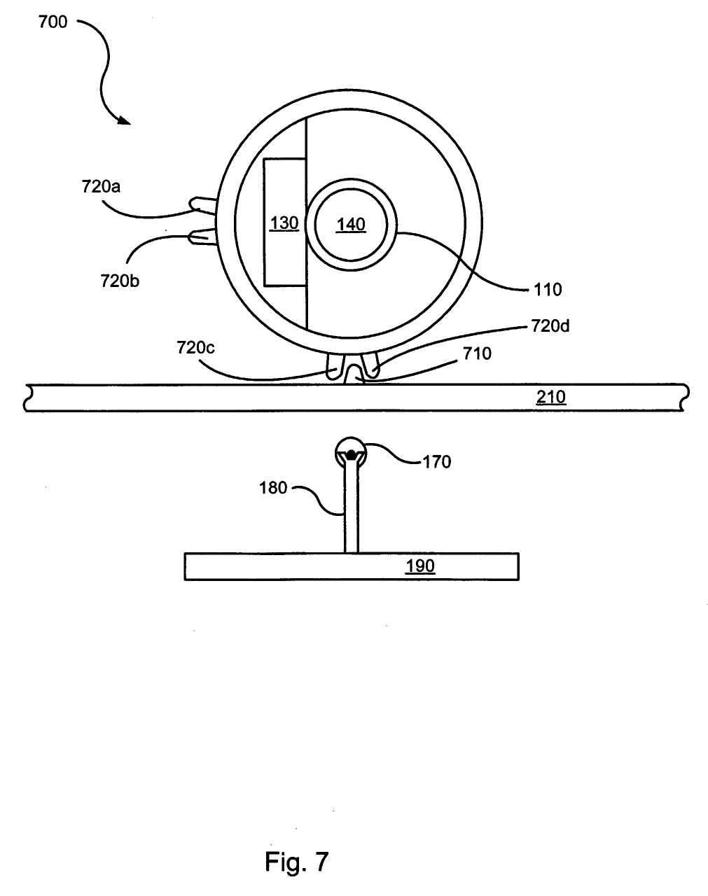

Turning to FIG. 7, a switch 700 including another locking feature in accordance with some embodiments of the present invention is depicted. Switch 700 includes various elements described in relation to other embodiments. In addition, switch 700 includes a plurality of catches 720 and a stopper 710 coupled to casing 210. When rotated, one of catches 720c and 720d flexibly moves past stopper 710 such that stopper 710 is trapped between catches 720c and 720d. In this position, switch 700 is held in the “off” position with field element 130 away from field activated switch 170. Switch 700 can be moved such that one of catches 720a and 720b flexibly moves past stopper 710 such that stopper 710 is trapped between catches 720a and 720. In this position, switch 700 is held in the “on” position with field element 130 adjacent field activated switch 170. As an alternative embodiment, one or more stoppers 710 can be formed as part of the rotator assembly with the catches formed on casing 210.

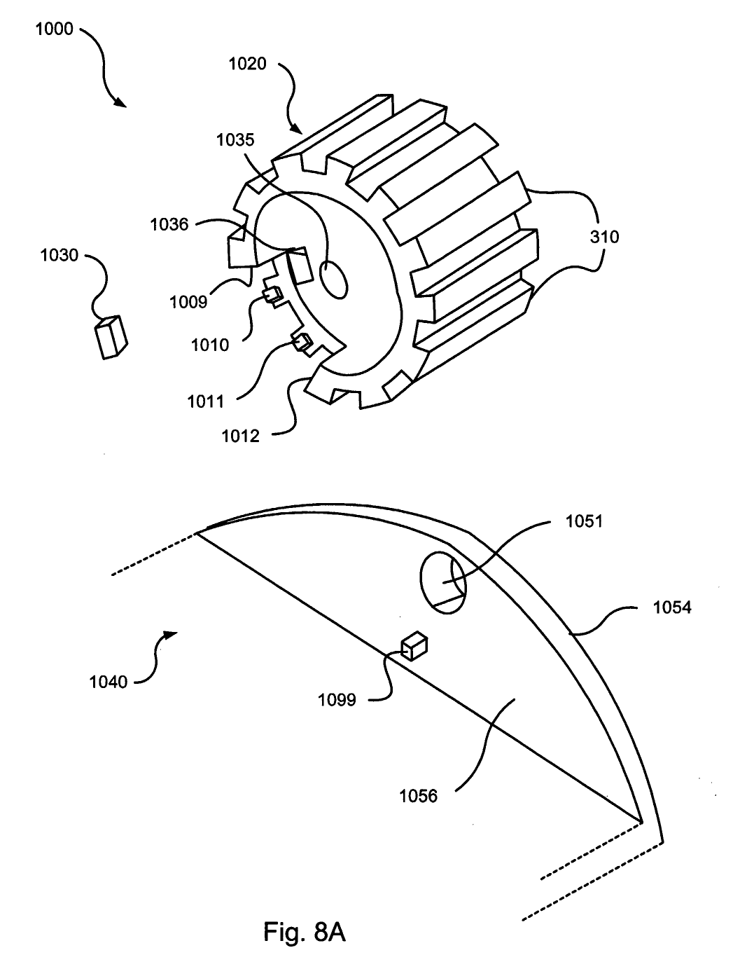

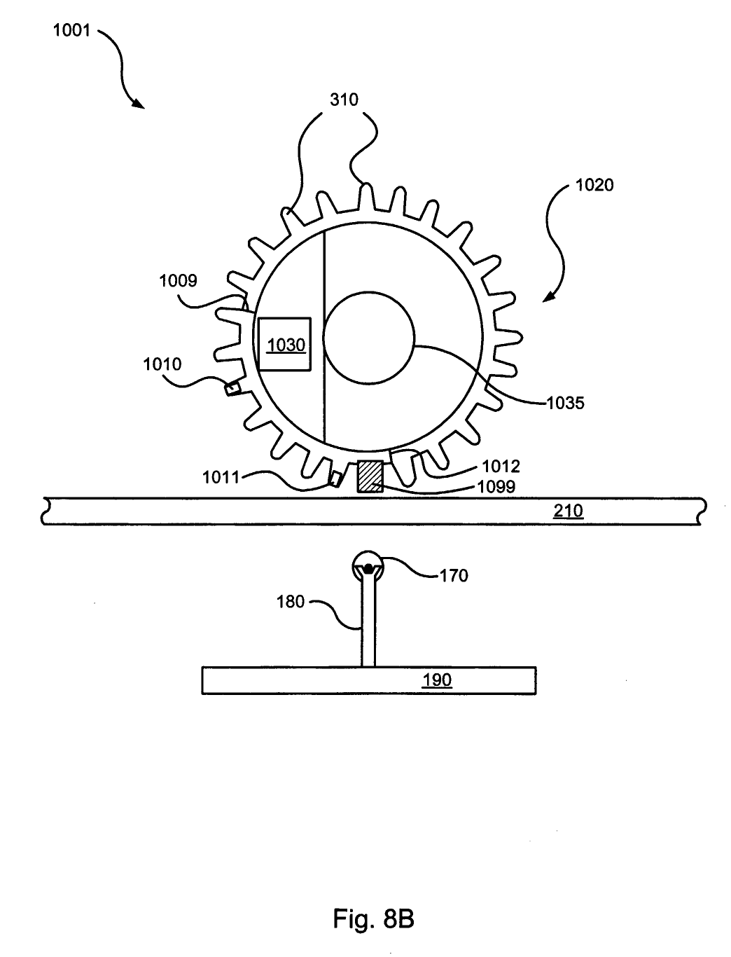

Turning to FIGS. 8, constituent portions 1020, 1040 of a switch 1000 including yet another locking feature in accordance with some embodiments of the present invention is depicted. Switch 1000 is somewhat similar to switch 100, thus only a side portion 1040 and actuator element 1020 is illustrated. As illustrated, actuator element 1020 has a cut out area where an on side stop 1010 and an off side stop 1011 are formed on the side of actuator element 1020. Further, actuator element 1020 has an on end stop 1009 and an off end stop 1012. A field element 1030 can be inserted into an opening 1036, and an opening 1035 can accept and axis around which actuator element 1020 can rotate.

Portion 1040 of a switch housing is also illustrated. As illustrated, the switch housing potion includes a side 1056 with an upper edge 1054, and an opening 1051 passing there through. As with switch 100, a shaft passing through opening 1051 and opening 1035 can couple actuator element 1020 to the switch housing. When coupled together, a boss 1099 extending from side 1056 interacts with on side stop 1010, off side stop 1011, on end stop 1009 and off end stop 1012. This interaction is shown in FIG. 8B where a side view 1001 of assembled switch 1000 is illustrated. When actuator element 1020 is rotated clockwise, boss 1099 snaps past off side stop 1011 and its progress is halted by off end stop 1012. In this position, actuator element 1020 is trapped in the “off” position with field element 1030 away from switch 170. Alternatively, where actuator element 1020 is rotated counter clockwise, boss 1099 snaps past off end stop 1012 and continues rotating until it snaps past on side stop 1010. Finally, its progress is halted by on end stop 1009. In this position, actuator element 1020 is trapped in the “on” position with field element 1030 near switch 170.

Based on the disclosure provided herein, one of ordinary skill in the art will recognize a number of shapes and sizes for boss 1099 and side stops 1010, 1011, as well as materials that can be used to form the elements in accordance with embodiments of the present invention. Considerations of a force required to snap past the side stops 1010, 1011, as well as durability considerations may play a role in determining size, shape and materials of the elements. Also, it should be noted that end stops 1009, 1012 can be replaced by additional side stops allowing actuator element to rotate through 360 degrees with the application of a moderate force. In such a case, there may not be a cut away area of an actuator element, but rather appropriate side stops may be formed on the side of an actuator elements, such as actuator element 120.

In some cases, a portion of the switch that interacts with the users thumb or finger operating the switch may be formed such that an depression or raised surface of the switch surface allows a user to feel whether the switch is on or off through touching the switch. Thus, as just one example, when the depression or raised surface of the switch is in a forward position, the switch is closed, and when the depression or raised surface is in a rearward position the switch is open. Based on the disclosure provided herein, one of ordinary skill in the art will recognize a variety of surface indentations or raised areas that may be used to give an indication of switch position.

In conclusion, the present invention provides novel systems, methods and arrangements for switching. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A durable switch comprising:
a switch housing, wherein the switch housing includes:
a channel defined by a channel base, at least one channel side extending away from the channel base, and at least one open end;
an actuator element, wherein the actuator element is rotatably mounted to the at least one channel side, wherein rotation of the actuator element causes an outer point of the actuator element to position at a point proximate the channel base, and wherein a passage through the open end is substantially larger than a passage between the outer point of the actuator element and the point proximate the channel base; and
a field element associated with the actuator element, wherein rotation of the actuator element causes a change in position of the field element.

2. The durable switch of claim 1, wherein the actuator element is capable of greater than one hundred, eighty degrees of rotation.

3. The durable switch of claim 2, wherein the actuator element is capable of three-hundred and sixty degrees of rotation.

4. The durable switch of claim 1, wherein the channel base is selected from a group consisting of: a planar channel base and a curvilinear channel base.

5. The durable switch of claim 1, wherein the actuator element has a generally cylindrical shape, wherein the outer point of the actuator element is disposed along an outer perimeter defined by the outer edge of the generally cylindrical shape.

6. The durable switch of claim 5, wherein the outer perimeter includes one or more denticles distributed along the outer edge.

7. The durable switch of claim 6, wherein the one or more denticles are operable to encourage an obstruction disposed in the channel toward the open end when the actuator is rotated.

8. The durable switch of claim 6, wherein the outer point is located at an area on one of the denticles most distant from the axis of rotation, and wherein upon rotation of the actuator element the outer point passes nearer to the channel base than to the open end.

9. The durable switch of claim 1, wherein the switch further comprises:
a field activated switch element, wherein the field activated switch element is responsive to the field element.

10. The durable switch of claim 9, wherein the response of the field activated switch element is based at least in part on the distance of the field activated switch element to the field element.

11. The durable switch of claim 1, wherein the field element is a magnet, wherein the switch further comprises a magnetically activated switch responsive to a magnetic field produced by the magnet.

12. The durable switch of claim 11, wherein the magnetically activated switch is disposed within a flashlight casing, and wherein the flashlight casing is factory sealed.

13. The durable switch of claim 12, wherein the actuator element and the switch housing are disposed outside the flashlight casing.

14. The durable switch of claim 13, wherein the switch housing is integral to the flashlight casing.

15. The durable switch of claim 1, wherein the open end is a first open end, wherein the channel side is a first channel side, wherein the channel is further defined by a second channel side opposite the first channel side and a second channel end opposite the first channel end, and wherein the actuator element is rotatably mounted on an axis extending from the first channel side to the second channel side.

16. A durable, non-clogging switch comprising:
a switch housing, wherein the switch housing comprises an open channel defined by a first side, a second side, and at least an open side;
an actuator element, wherein the actuator element is rotatably mounted between the first side and the second side of the switch housing, wherein at least a portion of the actuator element is disposed within the open channel, and wherein rotation of the actuator element is operable to displace an obstruction within the open channel toward the open side;
a magnet coupled to the actuator element; and
a magnetically activated switch disposed in relation to the switch housing, wherein rotation of the actuator element is operable to move the magnet within switching proximity of the magnetically activated switch.

17. The durable, non-clogging switch of claim 15, wherein the open side is a first open side, wherein the obstruction is a first obstruction, and wherein the open channel is further defined by a second open side opposite the first open side, and wherein rotation of the actuator element is further operable to displace the second obstruction toward the second open side.

18. The durable, non-clogging switch of claim 16, wherein the switch housing is integrated with a flashlight.

19. The durable, non-clogging switch of claim 18, wherein the magnetically activated switch is factory sealed within a casing of the flashlight.

20. A factory sealed flashlight, wherein the flashlight comprises:
a flashlight body, wherein the flashlight body is factory sealed surrounding a magnetically activated switch; and
a switch activator disposed in proximity to the magnetically activated switch, wherein the switch activator includes:
a switch housing, wherein the switch housing comprises an open channel defined by at least one side and at least an open end;
an actuator element, wherein the actuator element is rotatably mounted to the side of the switch housing, wherein at least a portion of the actuator element is disposed within the open channel, and wherein rotation of the actuator element is operable to displace an obstruction within the open channel toward the open end; and
a magnet coupled to the actuator element, wherein rotation of the actuator element is operable to move the magnet within switching proximity of the magnetically activated switch.
